(19) United States
(12) Patent Application Publication
(10) Pub. No.: US 2016/0081079 A1
(43) Pub. Date: Mar. 17, 2016

(54) BROADCASTING OR MULTICASTING OF SIGNALLING MESSAGES IN A WIRELESS NETWORK USING AN ACCESS NODE AS A BROKER

(71) Applicant: Nokia Technologies Oy, Espoo (FI)

(72) Inventors: Jarkko Lauri Sakari KNECKT, Espoo (FI); Janne MARIN, Espoo (FI); Mika KASSLIN, Espoo (FI)

(21) Appl. No.: 14/891,298

(22) PCT Filed: Jun. 6, 2013
(86) PCT No.: PCT/FI2013/050612

§ 371 Date: Nov. 13, 2015

(51) Int. Cl. H04W 72/04; H04W 72/00

(52) U.S. Cl. CPC H04W 72/0413; H04W 72/005

(57) ABSTRACT

A method, apparatus, and computer program for routing messages between terminal devices of a wireless network are provided. A terminal device of the wireless network generates a signaling message to be transmitted as a broadcast or multicast message to at least one other terminal device of the wireless network, causes transmission of the signaling message as a unicast message to the access node and, after transmitting the unicast message to the access node, receives the signaling message from the access node as the broadcast or multicast message. Further explanations: terminal devices (of a WLAN) broadcast or multicast control messages between each other by employing the access node (AP) as a broker for the signaling messages. For instance, channel reservation messages are encapsulated as unicast messages and sent to an AP to broadcast such reservation messages to other terminals competing for the same channel access. Each terminal adapts its channel reservations based on the information broadcasted by the other terminals via the AP. Alternatively, terminal devices may exchange information about the services they support.

### FIELD

The invention relates to the field of wireless networks and particularly, transmission of signaling messages in a wireless network.

### BACKGROUND

Several types of signaling or control messages are transmitted in a wireless network. These messages may be used to control transmissions in the wireless network.

### BRIEF DESCRIPTION

The invention is defined by the independent claims.

Embodiments of the invention are defined in the dependent claims.

### LIST OF DRAWINGS

Embodiments of the present invention are described below, by way of example only, with reference to the accompanying drawings, in which

FIG. 1 a wireless communication scenario to which embodiments of the invention may be applied;

FIG. 2 illustrates a flow diagram of a process for transmitting signaling messages in a wireless network according to an embodiment of the invention;

FIG. 3 is a flow diagram of an embodiment of FIG. 2;

FIG. 4 illustrates a signaling diagram of announcing channel reservations in the wireless network according to an embodiment of the invention;

FIG. 5 illustrates transmission timing of channel reservation messages according to an embodiment of the invention;

FIG. 6 illustrates a flow diagram of making decisions on channel reservations according to an embodiment of the invention; and

FIG. 7 is a block diagram of an apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A general wireless communication scenario to which embodiments of the invention may be applied is illustrated in FIG. 1. FIG. 1 illustrates wireless communication devices comprising an access point (AP) 100 and a plurality of terminal devices (STA) 104, 106. The AP 100 may be a stationary access point or a mobile access point. A general term used in this specification and encompassing both the APs and STAs is a wireless apparatus. The access point may refer to an access point specified in IEEE 802.11 specifications or to a base station of another wireless access network. At least one of the terminal devices 104, 106 may have a functionality of an AP as well. Therefore, a common term encompassing both the stationary APs 100 and mobile APs is an access node. An access node may provide or be comprised in a basic service set (BSS) which is a basic building block of an IEEE 802.11 wireless local area network (WLAN). Each access node may represent a different BSS. The most common BSS type is an infrastructure BSS that includes a single access node together with all STAs associated with the access node. The access node may provide access to other networks, e.g. the Internet 110. In another embodiment, the BSSs may be connected with each other by a distribution system (DS) to form an extended service set (ESS). An independent BSS (IBSS) is formed by an ad hoc network of terminal devices without a stationary controlling AP. While embodiments of the invention are described in the context of the above-described topologies of IEEE 802.11, it should be appreciated that these or other embodiments of the invention may be applicable to networks based on other specifications, e.g. WiMAX (Worldwide Interoperability for Microwave Access), UMTS LTE (Long-term Evolution for Universal Mobile Telecommunication System), mobile ad hoc networks (MANET), mesh networks, and other networks having cognitive radio features, e.g. transmission medium sensing features and adaptive capability to coexist with radio access networks based on different specifications and/or standards. Some embodiments may be applicable to networks having features under development by other IEEE task groups.

The different access nodes may operate at least partly on different channels, e.g. on different frequency channels. IEEE 802.11n specification specifies a data transmission mode that includes 20 megahertz (MHz) wide primary and secondary channels. The primary channel is used in all data transmissions with clients supporting only the 20 MHz mode and with clients supporting higher bandwidths. A further definition in 802.11n is that the primary and secondary channels are adjacent. The 802.11n specification also defines a mode in which a STA may, in addition to the primary channel, occupy one secondary channel which results in a maximum bandwidth of 40 MHz. IEEE 802.11ac task group extends such an operation model to provide for wider bandwidths by increasing the number of secondary channels from 1 up to 7, thus resulting in bandwidths of 20 MHz, 40 MHz, 80 MHz, and 160 MHz. A 40 MHz transmission band may be formed by two contiguous 20 MHz bands, and an 80 MHz transmission band may be formed by two contiguous 40 MHz bands. However, a 160 MHz band may be formed by two contiguous or non-contiguous 80 MHz bands. Different BSSs may employ different primary channels.

As mentioned above, the transmission band of a BSS contains the primary channel and zero or more secondary channels. The secondary channels may be used to increase data transfer capacity of a transmission opportunity (TXOP). The secondary channels may be called a secondary channel, a tertiary channel, a quaternary channel, etc. However, let us for the sake of simplicity use the secondary channel as the common term to refer also to the tertiary or quaternary channel, etc. The primary channel may be used for channel contention, and a TXOP may be gained after successful channel contention on the primary channel. Some IEEE 802.11 networks are based on carrier sense multiple access with collision avoidance (CSMA/CA) for channel access. Some networks may employ enhanced distributed channel access (EDCA) which provides quality-of-service (QoS) enhancements to medium access control (MAC) layer. The QoS enhancements may be realized by providing a plurality of access categories (AC) for prioritizing frame transmissions. The access categories may comprise the following priority levels in the order of increasing priority: background (AC_BK), best effort (AC_BE), video streaming (AC_VI), and voice (AC_VO). A higher priority frame transmission may use a shorter contention window and a shorter arbitration inter-frame spacing (AIFS) that result in higher probability of gaining the TXOP.

As described above, the BSS may be represented by the access node and one or more terminal devices connected to the access node. A terminal device 104, 106 may establish a connection with any one of the access nodes 100 it has detected to provide a wireless connection within the neighbourhood of the terminal device. The connection establishment may include authentication in which an identity of the terminal device is established in the access node. The authentication may comprise exchanging an encryption key used in the BSS. After the authentication, the access node and the terminal device may carry out association in which the terminal device is fully registered in the BSS, e.g. by providing the terminal device with an association identifier (AID). It should be noted that in other systems terms authentication and association are not necessarily used and, therefore, the association of the terminal device to an access node should be understood broadly as establishing a connection between the terminal device and the access node such that the terminal device is in a connected state with respect to the access node and scanning for downlink frame transmissions from the access node and its own buffers for uplink frame transmissions.

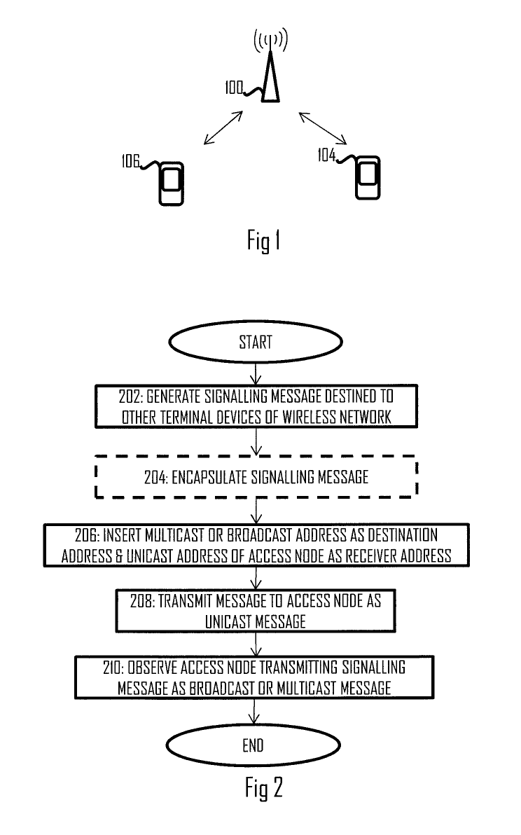

A typical scenario for exchanging signaling messages in a wireless network comprising the access node and the terminal devices is that the terminal devices scan for any broadcast or multicast signaling messages transmitted by the access node. Some embodiments of the invention provide a method for enabling the terminal devices to broadcast or multicast control messages by employing the access node as a broker for the signaling messages. FIG. 2 illustrates a flow diagram of a process for controlling the access node to broadcast or multicast control messages on behalf of a terminal device. The process may be carried out in an apparatus comprised in the terminal device.

Referring to FIG. 2, the terminal device generates a signaling message to be transmitted as a broadcast or multicast message to at least one other terminal device of the wireless network (block 202). In block 204, the terminal device encapsulates contents of the signaling message into a payload portion of an encapsulated message. The encapsulation may be used in connection with a tunneled connection. In some embodiments not using the tunneling, block 204 may be omitted. In block 206, the terminal device inserts a broadcast or multicast address as a destination address of the encapsulated message, and an individual address of an access node as a receiver address of the encapsulated message. The receiver address may define a receiver of a radio frame comprising the encapsulated message and transmitted by the terminal device, while the destination address may define a final destination of the encapsulated message. In block 208, the terminal device is arranged to transmit the encapsulated message as a unicast message to the access node. Thereafter, the terminal device may scan for any transmissions by the access node. In block 210, the terminal device detects, as a result of the scanning, that the access node transmits the encapsulated message as the broadcast or multicast message. The encapsulated message transmitted by the access node and the encapsulated message transmitted by the terminal device may be slightly different due to different addresses and transmission types, for example, but both may carry the signaling message generated in block 202.

In the embodiment of FIG. 2, the access node is configured to broadcast or multicast the signaling message in the wireless network on behalf of the terminal device. An advantage provided by this functionality is that the terminal devices may exchange control information, and a terminal device may broadcast or multicast control information it has generated in the whole wireless network. The transmissions of the access node reach all the terminal devices of the wireless network. Furthermore, in some embodiments (e.g. the embodiments using the tunneling) new signaling mechanisms may be created without the need for the access node to support the signaling mechanism. The encapsulated message may thus be transmitted to the other terminal devices through the access node transparently in the sense that the payload portion of the encapsulated message transmitted to the access node is substantially the same as the encapsulated message detected to be transmitted by the access node. This enables the use of legacy access nodes as brokers for the new signaling mechanisms.

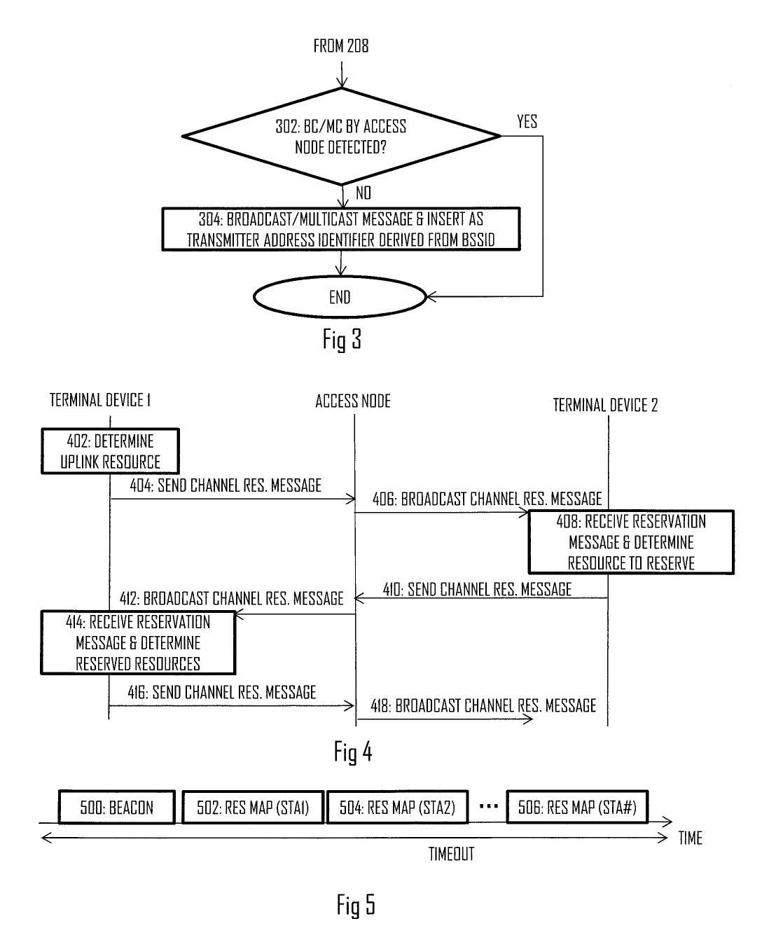

In an embodiment, the terminal device may be configured to ensure that the access node broadcasts or multicasts the signaling message (block 210). FIG. 3 illustrates a flow diagram of such an embodiment that may be executed in connection with the process of FIG. 2. After transmitting the unicast message to the access node, the terminal device may scan for the multicast or broadcast transmission of the signaling message it transmitted to the access node. Whether the terminal device scans for the multicast or broadcast transmission, depends on the destination address of the unicast message (a multicast address triggers scanning for multicast transmission while a broadcast address triggers scanning for broadcast transmission). In block 302, the terminal device determines whether or not it has detected the multicast or broadcast transmission. If the multicast or broadcast transmission has been detected, the process may end, as the access node has performed according to the expectations of the terminal device. On the other hand, if the multicast or broadcast transmission has not been detected within a determined time interval in block 302, the process may proceed to block 304 in which the terminal device carries out another transmission of the signaling message.

In some embodiments of block 304, the terminal device may retransmit the unicast message to the access node. In other embodiments of block 304, the terminal device may itself transmit the signaling message as the multicast or broadcast message. In the latter embodiment, the terminal device may modify the transmitter and the receiver address of the message it transmitted to the access node. The terminal device may insert the destination address as the receiver address, thus making a radio frame transmitted by the terminal device a multicast or broadcast frame. Additionally, the terminal device may insert as the transmitter address an identifier derivable from an identifier of the wireless network, e.g. an identifier derivable from a BSS identifier (BSSID) in an IEEE 802.11 network. This identifier may differ from the identifier of the terminal device used for transmitting frames to the access node. The identifier used as the transmitter address may be derived by incrementing the identifier of the wireless network by a determined number, e.g. BSSID+N. In an embodiment, N=2. The other terminal devices supporting this signaling mechanism are aware of the presence of such broadcast or multicast frames where the transmitter address is not the identifier of the wireless network but is derived from it and, thus, they are able to detect and decode the broadcast or multicast transmission of the terminal device. Providing a transmitter address that differs from the transmitter address used by the access node enables the other terminal device to distinguish the broadcast or multicast transmissions of the terminal devices from the broadcast or multicast transmissions of the access node.

In an embodiment, the terminal device may even be configured to carry out the broadcasts/multicasts in this manner without first trying to use the access node as the router. In such embodiments, the terminal device may directly transmit the signaling message to the broadcast/multicast address and insert the address derivable from the identifier of the wireless network as the transmitter address.

In some embodiments, traffic coordination indication frames are transmitted in the above-described manner. In other embodiments, the signaling message may carry service or device discovery information. For instance, the terminal devices in the wireless network may indicate the available services in the wireless network. A terminal device may use the information to discover other terminal devices for a tunneled direct link setup where two terminal devices associated to the same wireless network transmit data to each other directly and the access node does not forward the frames. In other embodiments, the multicast data may be shared locally in the above-described manner, e.g. audio, video or gaming-related data that is targeted to devices in proximity. The multicast data is thus locally shared to all terminal devices in proximity of a terminal device originating the data. Data content of the terminal devices may be synchronised with the multicasted data.

With respect to the traffic coordination indication frames, the traffic coordination indication frames may comprise uplink channel reservation messages in which the terminal devices may announce uplink channel reservations they have made. The reserved channel resources may then be used for transmitting uplink payload data from the terminal device to the access node. Announcing the channel reservations may be used to prevent collisions in the channel used by the terminal devices of the wireless network. FIG. 4 illustrates a signaling diagram of an embodiment for using the access node as the broker for the uplink channel reservation messages. Referring to FIG. 4, a first terminal device determines to make a channel reservation for uplink transmission and selects an uplink channel resource to reserve (block 402). The determination may be based on determining that that it has uplink traffic available for transmission or, in case of constant transmission of traffic typical for real-time applications, the reservation may be made in connection with establishing a connection with the access node. The selected uplink channel resource may be understood as a time resource defining a time interval for which one or more frequency channels of the wireless network are reserved for the first terminal device.

In step 404, the first terminal device may carry out steps 202 to 208 and, accordingly, generate the uplink channel reservation message defining the uplink channel resource the first terminal device reserves and transmit it as the unicast frame to the access node. Upon receiving the unicast frame addressed to it, the access node may determine the destination address of the unicast frame, detect the destination address to be an address of the wireless network of the access node or a broadcast/multicast address, and broadcast or multicast the frame in the wireless network in step 406. In block 408, a second terminal device detects the frame broadcasted or multicasted by the access node. The second terminal device may detect the received frame to be the uplink channel reservation message and extract the contents of the uplink channel reservation message. Accordingly, the second terminal device becomes aware of the uplink channel reservation made by the first terminal device. The reservation of the first terminal device may become valid for the first terminal device upon transmitting the channel reservation message to the access node or upon detecting the access node broadcasting/multicasting the frame and for the second terminal device upon extracting the contents of the received uplink channel reservation message. Possible conflicts in reservations may be handled according to state-of-the-art solutions.

Upon gaining information on the pending reservations of the first terminal device and, possibly, other terminal devices of the wireless network, the second terminal device may determine an uplink channel resource to reserve by taking into account the pending reservations and reservation rules applied in the wireless network. Embodiments of the reservation rules are described below. In block 408, the second terminal device determines an uplink resource to be reserved and, in step 410, it carries out blocks 202 to 208 and transmits the uplink channel reservation message indicating the reservation as the unicast message to the access node. In an embodiment, the terminal device includes in the transmitted uplink channel reservation message a pending reservation of the first terminal device and the new reservation of the second terminal device. Upon receiving the unicast message in step 410, the access node carries out the broadcasting/multicasting of the message in step 412 in the above-described manner (similar to step 406).

In block 414, the first terminal device receives the broadcast/multicast uplink channel reservation message from the access node and determines the pending reservations from the received message. At this instant, the first terminal device may choose not to make any new reservations. The first terminal device may, however, be configured to periodically announce the pending reservations. As a consequence, the first terminal device may generate a new uplink channel reservation message comprising the pending channel reservations and send the uplink channel reservation message as the unicast message to the access node in step 416. The pending reservations may comprise the pending reservations of at least both the first terminal device and the second terminal device. Again, the access node may be configured to relay the received unicast message as the multicast/broadcast message in the wireless network (step 418).

Each message transmitted and received may be acknowledged by a receiver.

Above, the channel reservations are made for the uplink transmissions. Accordingly, the terminal device may receive downlink transmissions from the access nodes in non-reserved channel resources, e.g. in resources not indicated to be reserved in any channel reservation message. In other embodiments, downlink transmission resources may be reserved in a similar manner. Accordingly, the uplink channel reservation message may be generalized into a form of a channel reservation message indicating pending and/or new channel reservations including uplink and/or downlink reservations. For the sake of clarity, uplink may be defined as a communication direction from the terminal device to the access node, while the downlink may be defined as a communication direction from the access node to the terminal device. Some embodiments such as those implemented in IEEE 802.11 networks may limit the reservations made by the terminal devices to uplink reservations.

In the above-described manner, the terminal devices of the wireless network may keep track of the pending reservations, make new reservations, and announce the new and pending reservations. The terminal devices may be configured to transmit the uplink channel reservation messages to the access node at arbitrary time instants. The access node, however, may be configured to transmit broadcast or multicast frames at determined time intervals in order to enable the terminal devices of the wireless network to receive them and to enter a power-save mode at other time instants. In an IEEE 802.11 network, the access node may be configured to broadcast or multicast the uplink channel reservation messages within a determined time interval after transmitting a beacon frame. The beacon frame may comprise a deliver traffic indication map or message (DTIM) indicating availability of downlink traffic for the terminal devices. The DTIM beacon may be transmitted with a predetermined timing defined by a target beacon transmission timing TBTT, which enables the terminal devices to wake up from the power-save mode to receive the DTIM. The DTIM beacon may be transmitted on time or after the TBTT, depending on the channel occupation on the TBTT. The terminal devices may stay awake for a determined time interval starting from the TBTT, which enables them to receive any further broadcast/multicast transmissions after the DTIM beacon. This time interval may be defined as dot11BroadcastDeliveryTimeout, and it is illustrated in FIG. 5 by “timeout”. Referring to FIG. 5, after transmitting the beacon 500 comprising the DTIM, the access node may be configured to broadcast/multicast the signaling messages 502, 504, 506 it has received from the terminal devices of its network as the unicast frames. The access node may transmit a signaling message of each terminal device as a separate broadcast/multicast message 502 to 506. In the embodiment where the signaling message is the channel reservation message, the signaling messages may comprise a reservation map indicating the pending reservations and one or more new reservations made by the terminal device that originated the signaling message. The access node may transmit the signaling messages up to the expiry of the timeout. If the access node could not transmit all the messages it may resume the transmission after the next DTIM beacon.

In an embodiment, the access node indicates the last broadcast/multicast message it intends to transmit before the expiry of the timeout. This enables the terminal devices using the power-save mode to doze before the expiry of the timeout. The value of the timeout may be a few milliseconds (ms), e.g. 3 ms.

A terminal device may be configured to transmit the channel reservation message when it makes a new channel reservation, as described above. In an embodiment, the terminal device transmits the channel reservation message when it detects that a channel reservation message by another terminal device comprises incorrect information, e.g. a reservation known to be pending is missing from the reservation map or indicates incorrect channel resource. Upon detecting the incorrect information being announced by another terminal device, the terminal device may send a new channel reservation message that corrects the false information. In order to avoid ping-ponging of announcing correct and incorrect reservations, the terminal device may be configured to correct only the false information of its own reservations announced by the other terminal device. The terminal device may determine that when another terminal device announces its own reservations, the information on the reservation is always correct. Accordingly, the terminal device may remove any discrepancies in its own records. In an embodiment, the terminal device transmits the channel reservation message periodically, e.g. a determined time after the TBTT or every second TBTT. In an embodiment, the terminal device may omit transmission of the channel reservation message if it has received another channel reservation message of another terminal device within a determined time interval before an intended transmission timing of the channel reservation message. A further condition may be that the terminal device intends to make no new reservations. In this manner, the terminal device may omit immediately repeating the information that has just been announced by the other terminal device.

A terminal device capable of making the channel reservations may set a field of a medium access control (MAC) header or a physical layer convergence protocol (PLOP) header of the channel reservation message to a specific value to indicate the capability to the other terminal devices. In another embodiment, the capability may be indicated by selecting a dedicated value of a Subnetwork Access Protocol (SNAP) or Logical Link Control (LLC) header to the transmitted reservation messages.

If a terminal device does not receive a channel reservation message from another terminal device that is known to have pending reservations within a determined time interval, e.g. a multiple of DTIM beacon intervals, the terminal device may be configured to remove the reservations of the terminal device from the channel reservation messages the terminal device transmits. The pending reservations may also be removed when making a new reservation.

Let us now consider some embodiments of the rules for making the reservations. In wireless networks having no dedicated uplink and downlink resources, such as IEEE 802.11 networks, all the communication resources are in principle available for reservation for uplink and/or downlink transmissions. The terminal devices may, however, make the reservations specifically for uplink or downlink transmissions. Let us consider only uplink reservation in the description below. Accordingly, the terminal device does not make any downlink reservations in the described embodiments. When selecting transmission timing and duration for the reservation, the terminal device may take into account any pending reservations and the amount of unreserved resources. The terminal device may be configured to leave a certain amount of resources unreserved such that resources remain for the downlink transmissions. When making the reservation, the terminal device may leave some unreserved time after each reservation in order to allow downlink transmissions in downlink service periods following the reservations.

In an embodiment, the terminal device may also consider the TBTT and avoid making any reservations at a determined time interval before and/or after the TBTT in order to allow the access node to broadcast and/or multicast the beacon and the channel reservation messages.

In an embodiment, the terminal device makes static reservation in the form of a periodic reservation defined by a timing offset, duration, and periodicity of the reservation. The terminal device may be allowed to use the reserved resources in an arbitrary manner, e.g. to transmit one or more frames within a single reservation or have one or more TXOPs within a single reservation.

In an embodiment, the terminal device considers the above-mentioned access categories when making a new reservation. The terminal device may determine an access category of traffic it intends to transmit during the new reservation and compare the access categories of pending reservations. The terminal device may determine whether or not to allow overlapping reservations on the basis of the access categories. In an embodiment, the terminal device avoids making overlapping reservations for traffic within a first subset of access categories while it may allow overlapping reservations for traffic within a second subset of access categories different from the first subset of access categories. FIG. 6 illustrates a flow diagram of such an embodiment. Referring to FIG. 6, the terminal device determines the pending reservations and their access categories from one or more received channel reservation messages (block 600). In block 602, the terminal device determines the access category of the traffic it intends to transmit. If the access category is high, e.g. voice (AC_VO) and video (AC_VI), the process may proceed to block 604 in which the terminal device makes a reservation that does not overlap with any other reservation having said high access category.

Additionally, the terminal device may select the timing of the reservation such that a determined guard period remains between two consecutive reservations having the high access category. In an embodiment, the terminal device may apply a short guard period between the two consecutive reservations having the high access category, e.g. less than 3 ms. This may maximize the capacity and the resources for unreserved traffic. In another embodiment, the terminal device may apply a long guard period between the two consecutive reservations having the high access category, e.g. more than 3 ms. This may reduce the probability that two terminal devices competes simultaneously for obtaining a TXOP for high-access-category traffic and, the number of collisions.

Even in embodiments allowing overlapping of reservations having high access categories, the terminal device may select a start time for the reservation such that it does not overlap with a start time of a pending reservation. A certain guard time may be provided around the start time of the pending reservation such that the terminal device cannot make a reservation start within the guard time. This embodiment reduces the probability that two terminal devices making a high-access-category channel contention end up in a collision. Contention with high access categories increases the probability that the two terminal devices both assume to have acquired the channel access, which may result in the collision.

Referring to FIG. 6 and block 602, if the terminal device determines that its access category is low, e.g. AC_BE or AC_BK, the process may proceed to block 606 in which the terminal device may make a reservation that overlaps with a pending reservation having a high access category, e.g. AC_VO or AC_VI. Allowing overlapping of reservations of different access categories may improve the capacity of the wireless network without increasing the probability of the collisions significantly. The reason for avoiding collisions is that the terminal device having the higher access category in its reservation is more likely to acquire the TXOP because of the rules of EDCA. Additionally, the real need of resources needed for the traffic having the low access category may be relatively difficult to estimate beforehand and, therefore, the reserved resources are used by another terminal device when the terminal device has no low-access-category traffic to transmit.

The terminal devices may have configured a maximum number of simultaneous reservations allowed in the wireless network. The maximum number of simultaneous reservations may take into account the reservations of all terminal devices of the wireless network. A separate maximum number of simultaneous reservations may be configured for each access category. If the number of simultaneous reservations exceeds the maximum number of reservations, the terminal devices may be configured to use a reservation conflict resolution mechanism. The reservation conflict mechanism may comprise a rule to determine a terminal device that needs to change its reservation timing or cancel its reservation. In one embodiment, the terminal device is selected by comparing values of the MAC addresses of the terminal devices that have reservations and selecting the terminal device with the smallest (or highest) MAC address value. To make the comparison random and fair, the terminal device having the smallest value may be determined according to the following equation:

Value=BSSID[0 . . . 13]+device's MAC address[0 . . . 13] Mod(14).

In the BSSID value, 14 least significant bits may be used.

Let us now describe some embodiments of the channel reservation message. The channel reservation message may comprise one or more traffic coordination element indicating the reserved resource(s). Table 1 below illustrates an embodiment of the traffic coordination element.

TABLE 1

| | | Coord. | STA 1 | | STA N Reservation |
|---|---|---|---|---|---|
| Element ID | Length | Options | reservation | . . . | (optional) |
| Octets: 1 | 1 | 1 | 7 | . . . | 7 |

Element identifier (ID) field may identify the traffic coordination element and Length field may describe its length. Coordination Options field may have the following contents:

TABLE 2

| Power Save | |
|---|---|
| Mandatory | Number of STAs |
| Bits: 1 | 7 |

The Power Save Mandatory field may be set to one value to indicate that the terminal device supporting the reservations operates in the power-save mode and, otherwise, the bit may be set to the other value. The operation in the power-save mode may limit the downlink transmissions to the service periods following the uplink transmissions and it may reduce the number transmissions by the access node to the terminal device.

The Number of STAs indicates the number of pending uplink reservations in the wireless network, including the new reservation made by the terminal device (if applicable). The number may be the same as the number of reported reservations in the traffic coordination element.

Table 3 below illustrates contents of the STA X Reservation element of Table 1:

TABLE 3

| | | | | Res. |
|---|---|---|---|---|
| MAC Addr. | ACs | Res. Offset | Res. Duration | Periodicity |
| Octets: 2 | 1 | 2 | 1 | 1 |

The MAC Address field may identify the terminal device whose reservation is reported in the reservation element. The identifier may be a partial MAC address, e.g. 16 least significant bits [0:15] of the MAC address. Full MAC address may not be needed to identify the terminal devices in this context.

The Access Categories (ACs) field may contain a following bit field:

TABLE 4

| AC_BK | AC_BE | AC_VI | AC_VO | Reserved |
|---|---|---|---|---|
| Bits: 1 | 1 | 1 | 1 | 4 |

The AC-specific bit is set to one value to indicate that during the reservation the terminal device intends to transmit traffic from the specified AC and otherwise the AC-specific bit is set to the other value. In some embodiments, the wireless network may limit the terminal devices to include traffic only from a single AC per reservation.

The Reservation Offset field may be an unsigned integer in units of 1/20 time units (TU), e.g. 51.2 μs. The Reservation Offset field may indicate the time offset to the reservation from the previous TBTT or from another time reference of the wireless network.

The Reservation Duration field may be an unsigned integer in units of 1/10 TU, e.g. 104.2 μs. The Reservation Duration field may indicate the duration of the reservation.

The Reservation Periodicity field may be an unsigned integer in units of 1/10 TU, e.g. 104.2 μs. The Reservation Periodicity field may indicate the time between the start times of two consecutive reservations.

In the above-described embodiments, the terminal device uses the above-described channel reservation principles with the signaling message distribution functionality described above in connection with FIGS. 2 and 3. In other embodiments, the terminal device uses the channel reservation principles without the signaling message distribution functionality. The terminal device may then determine pending reservations from one or more signaling messages received from the access node and/or from one or more other terminal devices. Upon determining the pending reservations, the terminal device may select a channel resource to be reserved on the basis of the pending reservations and according to determined reservation rules. The channel resource selection may be made by the terminal device autonomously. The terminal device may then announce the reservation it has made to the other terminal device(s) and/or the access node by causing transmission of a channel reservation message. The channel reservation message may be sent as a unicast, multicast, or broadcast message.

The embodiment using the tunneled signaling scheme and encapsulation/decapsulation of the signaling messages may be implemented in the terminal device by modifying a protocol stack of the terminal device, as described in Table 5 below:

TABLE 5

Application
Transport Control Protocol
Internet Protocol
Logical Link Control &
Transmission Coordination
Medium Access Control
Physical

A transmission coordination unit may be added to a link layer protocol of the terminal device. In an embodiment, the transmission coordination unit may be added to an upper link layer protocol which, in some wireless networks, is called logical link control (LLC). The LLC layer may multiplex protocols over the MAC layer and/or provide flow control and error control features, for example. The operations of the transmission coordination unit may execution of blocks 202 to 206, e.g. generation of the signaling messages to be announced to other terminal devices, encapsulation of these signaling messages and controlling their transmission as the unicast messages to the access nodes and, from there on, as multicast or broadcast messages to the other terminal devices, reception, decapsulation, and extraction of the corresponding signaling messages from the other terminal devices. Furthermore, in the embodiments applying the channel reservation features, the transmission coordination unit may receive channel reservation messages from in the signaling messages and making channel reservations on that basis. The transmission coordination unit may, for example, decide timing of a new reservation, duration of the new reservation, delay data that is received from a higher layer for transmission until the reserved resource becomes available, and/or coordinate the usage of the reserved resources and/or balance the reserved resources according to resource need by using the above-described reservation rules. The properties of the reservation such as the timing and duration may be decided based on an application type providing traffic or stream setup signaling received from the application layer.

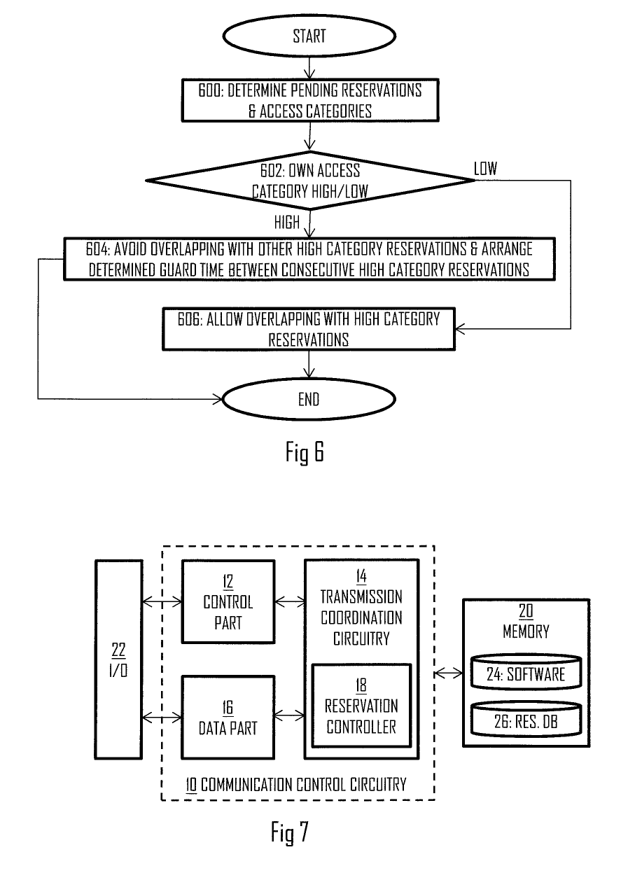

FIG. 7 illustrates an embodiment of an apparatus comprising means for carrying out the above-mentioned functionalities of the terminal device. The terminal device may comply with specifications of an IEEE 802.11 network and/or another wireless network. The terminal device may also be a cognitive radio apparatus capable of adapting its operation to a changing radio environment, e.g. to changes in parameters of another system on the same frequency band. The terminal device may be or may be comprised in a computer (PC), a laptop, a tablet computer, a cellular phone, a palm computer, or any other wireless apparatus provided with radio communication capability. In another embodiment, the apparatus carrying out the above-described functionalities of the terminal device is comprised in such a wireless apparatus, e.g. the apparatus may comprise a circuitry, e.g. a chip, a processor, a micro controller, or a combination of such circuitries in the wireless apparatus.

Referring to FIG. 7, the apparatus may comprise a communication controller circuitry 10 configured to control wireless communications in the terminal device. The communication controller circuitry 10 may configure the establishment, operation, and termination of connections or associations in the apparatus, as described above. The communication controller circuitry 10 may comprise a control part 12 handling control signaling communication with respect to transmission, reception, and extraction of control or management frames including the above-described signaling messages etc. The control part 12 may additionally carry out channel sensing procedures in order to scan the channel(s) of the wireless network for broadcast and multicast messages addressed to the terminal device. The communication controller circuitry 10 may further comprise a data part 16 that handles transmission and reception of payload data when the terminal device is associated to one or more access nodes and/or to one or more wireless devices.

The communication control circuitry 10 may further comprise a transmission coordination circuitry 14 configured to carry out at least some of the above-described embodiments. In an embodiment, the transmission coordination circuitry 14 is configured carry out the functions of the above-described transmission coordination unit. The transmission coordination circuitry may thus generate signaling messages to be broadcasted or multicasted to other terminal devices of the same wireless network. The transmission coordination circuitry 14 may configure the control part to broadcast or multicast the signaling messages directly to the other terminal devices, or the transmission coordination circuitry 14 may encapsulate the signaling messages and transmit the encapsulated messages as unicast messages to the access node such that the access node broadcasts or multicasts the signaling messages on behalf of the apparatus. In some embodiments where the access nodes support the transmission coordination messages originated from the terminal devices, such as the channel reservations made by the terminal device on their own volition, the transmission coordination circuitry 14 may even send the unicast signaling messages to the access node without the encapsulation and the access node, upon receiving the signaling messages forwards them as the broadcast/multicast messages to the other terminal devices of the wireless network.

In some embodiments, the communication control circuitry 10 further comprises a channel reservation controller circuitry 18 configured to process channel reservation messages received through the control part 12. The channel reservation controller circuitry 18 may be configured to store the pending reservations in a reservation database 26 stored in a memory 20 of the apparatus. The channel reservation controller circuitry 18 may be configured to carry out channel reservations on the basis of pending reservations and rules described above, for example. The channel reservation controller circuitry 18 may then generate new channel reservation messages defining the newly reserved channel resources and cause the control part 12 to transmit the new channel reservation messages to the access node and/or the other terminal devices, as described above.

The circuitries 12 to 18 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 18 or all of them.

The apparatus may further comprise the memory 20 that stores computer programs (software) 24 configuring the apparatus to perform the above-described functionalities of the terminal device. The memory 20 may also store communication parameters and other information needed for the wireless communications, e.g. addresses and other parameters assigned to the terminal device with respect to different associations. The apparatus may further comprise radio interface components 22 providing the apparatus with radio communication capabilities within one or more wireless networks. The radio interface components 22 may comprise standard well-known components such as an amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the terminal device comprises at least one processor and at least one memory including a computer program code, wherein the at least one memory and the computer program code are configured, with the at least one processor, to cause the apparatus to carry out the functionalities of the terminal device according to any one of the embodiments of FIGS. 2 to 6. Accordingly, the at least one processor, the memory, and the computer program code form processing means for carrying out embodiments of the present invention in the terminal device.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 6 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to wireless communication systems defined above but also to other suitable wireless communication systems. The protocols used, the specifications of systems, their network elements and terminal devices, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1-29. (canceled)

30. A method comprising:
generating, in a terminal device of a wireless network, a signaling message to be transmitted as a broadcast or multicast message to at least one other terminal device of the wireless network;
causing transmission of the signaling message as a unicast message to an access node; and
after transmitting the unicast message to the access node, receiving the signaling message from the access node as the broadcast or multicast message.

31. The method of claim 30, further comprising encapsulating contents of the signaling message into a payload portion of the unicast message, causing transmission of the unicast message to the access node, and receiving the encapsulated contents of the signaling message from the access node as the broadcast or multicast message.

32. The method of claim 31, wherein the encapsulated signaling message is transmitted to the at least one other terminal device through the access node transparently such that the payload portion of the unicast message transmitted to the access node is substantially the same as a payload portion in the broadcast or multicast message received from the access node.

33. The method of claim 30, further comprising in the terminal device:
inserting a broadcast or multicast address as a final destination address of the unicast message;
inserting an individual address of an access node as a receiver address of the unicast message.

34. The method of claim 30, wherein the signaling message comprises control information for the at least one other terminal device of the wireless network.

35. The method of claim 30, wherein the signaling message is a channel reservation message indicating reservation of at least one channel resource.

36. The method of claim 35, further comprising in the terminal device:
before forming the signaling message, receiving a second channel reservation message as a broadcast or multicast message;
determining the reservation of the at least one channel resource on the basis of the second channel reservation message such that the reservation of the at least one channel resource does not overlap with another channel resource reservation indicated in the second channel reservation message.

37. The method of claim 35, wherein the channel reservation message indicates channel reservations of a plurality of terminal devices of the wireless network.

38. The method of claim 35, further comprising in the terminal device: causing transmission of a unicast frame to the access node in the reserved at least one channel resource.

39. An apparatus comprising:
at least one processor; and
at least one memory including a computer program code, wherein the at least one memory and the computer program code are configured, with the at least one processor, to cause the apparatus to:
generate a signaling message to be transmitted as a broadcast or multicast message to at least one terminal device of a wireless network;
cause transmission of the signaling message as a unicast message to an access node; and
after transmitting the encapsulated message to the access node, receive the signaling message from the access node as the broadcast or multicast message.

40. The apparatus of claim 39, wherein the at least one memory and the computer program code are configured, with the at least one processor, to cause the apparatus to encapsulate contents of the signaling message into a payload portion of the unicast message, cause transmission of the unicast message to the access node, and receive the encapsulated contents of the signaling message from the access node as the broadcast or multicast message.

41. The apparatus of claim 40, wherein the at least one memory and the computer program code are configured, with the at least one processor, to cause the apparatus to transmit the encapsulated signaling message to the at least one other terminal device through the access node transparently such that the payload portion of the unicast message transmitted to the access node is substantially the same as a payload portion in the encapsulated message received from the access node.

42. The apparatus of claim 39, wherein the at least one memory and the computer program code are configured, with the at least one processor, to cause the apparatus to:
determine that the access node has not transmitted the signaling message as the broadcast or multicast message,
in response to said determining, cause transmission of the encapsulated message as a broadcast or multicast message from the terminal device, wherein a broadcast or multicast address is inserted into a receiver address of the broadcast or multicast message, and wherein an identifier derived from an identifier of the wireless network is inserted into a transmitter address of the broadcast or multicast message.

43. The apparatus of claim 39, wherein the at least one memory and the computer program code are configured, with the at least one processor, to cause the apparatus to:
insert a broadcast or multicast address as a final destination address of the unicast message;
insert an individual address of an access node as a receiver address of the unicast message.

44. The apparatus of claim 39, wherein the signaling message comprises control information for the at least one other terminal device of the wireless network.

45. The apparatus of claim 39, wherein the signaling message is a channel reservation message indicating reservation of at least one channel resource.

46. The apparatus of claim 45, wherein the at least one memory and the computer program code are configured, with the at least one processor, to cause the apparatus to:
before forming the signaling message, receive a second channel reservation message as a broadcast or multicast message;
determine the reservation of the at least one channel resource on the basis of the second channel reservation message such that the reservation of the at least one channel resource does not overlap with another channel resource reservation indicated in the second channel reservation message.

47. The apparatus of claim 45, wherein the channel reservation message indicates channel reservations of a plurality of terminal devices of the wireless network.

48. The apparatus of claim 45, wherein the at least one memory and the computer program code are configured, with the at least one processor, to cause the apparatus to cause transmission of a unicast frame to the access node in the reserved at least one channel resource.

49. A non-transitory computer readable memory embodying at least one computer program code, the at least one computer program code executable by at least one processor to perform a method comprising:
generating, in a terminal device of a wireless network, a signaling message to be transmitted as a broadcast or multicast message to at least one other terminal device of the wireless network;
causing transmission of the signaling message as a unicast message to an access node; and
after transmitting the unicast message to the access node, receiving the signaling message from the access node as the broadcast or multicast message.
